(19) United States
(12) Patent Application Publication
(10) Pub. No.: US 2025/0108877 A1
(43) Pub. Date: Apr. 3, 2025

(54) VEHICLE SUSPENSION SYSTEM

(71) Applicant: Guangzhou Tufa network technology Co., LTD, Guangzhou (CN)

(72) Inventors: Bowen WANG, Guangzhou (CN); Yi SHI, Guangzhou (CN)

(73) Assignee: Guangzhou Tufa network technology Co., LTD, Guangzhou (CN)

(21) Appl. No.: 18/970,798

(22) Filed: Dec. 5, 2024

Related U.S. Application Data
(63) Continuation of application No. PCT/CN2024/104138, filed on Jul. 8, 2024.

(30) Foreign Application Priority Data
Oct. 1, 2023 (CN) 202311291738.3
Jun. 28, 2024 (CN) 202410866240.3

(51) Int. Cl. B62K 25/04; B62K 5/08

(52) U.S. Cl. CPC B62K 25/04; B62K 5/08

(57) ABSTRACT

This disclosure provides a vehicle suspension system. Actuating elements disposed on two sides of a vehicle body provide acting forces for the vehicle body, so that the vehicle body is in an equilibrium position. When the vehicle body deviates from the equilibrium position, a resultant force generated by the two actuating elements causes the vehicle body to return to the equilibrium position. The vehicle suspension system can overcome the problems that a vehicle body is easy to shake and difficult to balance due to a high degree of freedom of wheels in a suspension system connected by a linkage mechanism.

### RELATED APPLICATIONS

This application is a continuation application of PCT application No. PCT/CN2024/104138, filed on Jul. 8, 2024, which claims the benefit of priority of Chinese application numbers CN 2023112917383 filed on Oct. 1, 2023, and CN 2024108662403 filed on Jun. 28, 2024, and the contents of the foregoing documents are incorporated herein by reference in entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This disclosure relates to the field of vehicle technologies, and in particular, to a vehicle suspension system.

### BACKGROUND

With development of science and technology, various commuter vehicles have appeared, bringing great convenience to people's lives. In particular, short-distance commuter vehicles, such as kick scooters, tricycles, and self-balancing scooters, are increasingly used. People can drive commuter vehicles while standing thereon. The commuter vehicles are small and light, suitable for traveling in narrow space, and have great advantages in ultra-short-distance travel. A suspension system of a short-distance commuter vehicle in the existing technology uses a linkage structure, which makes the commuter vehicle easy to shake in the left and right directions, unable to balance, and prone to rollover.

Therefore, a new vehicle suspension system needs to be provided to improve vehicle stability and safety.

Content of the background section is only information known to the inventor personally, and neither represents that the information has entered the public domain before the filing date of the present disclosure, nor represents that it can become the prior art of the present disclosure.

### SUMMARY

This disclosure provides a vehicle suspension system to resolve a problem existing in the related art.

This disclosure provides a vehicle suspension system, including: a multi-linkage mechanism, which connects a vehicle body and a pair of wheels, where the pair of wheels includes a first wheel and a second wheel respectively located on two sides of the vehicle body; and a restoring apparatus, including a pair of actuating elements distributed on both sides of the vehicle body, where one of the pair of actuating elements connects the vehicle body and the first wheel, the other one of the pair of actuating elements connects the vehicle body and the second wheel, and the pair of actuating elements is configured to provide acting forces, so that the vehicle body is in an equilibrium position under a resultant force of the acting forces, where when the vehicle body deviates from the equilibrium position, the resultant force of the acting forces drives the vehicle body to return to the equilibrium position.

In summary, in the vehicle suspension system provided in this disclosure, the actuating elements disposed on both sides of the vehicle body provide acting forces for the vehicle body, so that the vehicle body can be in the equilibrium position. When the vehicle body deviates from the equilibrium position, the resultant force generated by the two actuating elements causes the vehicle body to return to the equilibrium position. The vehicle suspension system provided in this disclosure can overcome the problems that a vehicle body is easy to shake and difficult to balance due to a high degree of freedom of wheels in a suspension system connected by a linkage mechanism. The vehicle suspension system provided in this disclosure can also achieve steering through the steering mechanism, and can achieve automatic steering via the driving apparatus, thereby broadening use scenarios of the vehicle and enabling the vehicle to be in a self-driving state.

Other functions of the vehicle suspension system provided in this disclosure are partially listed in the following description. Based on the description, content described in the following figures and examples is obvious to a person of ordinary skill in the art. Creative aspects of the vehicle suspension system provided in this disclosure may be fully explained by practicing or using the method, apparatus, and a combination thereof provided in the following detailed examples.

### BRIEF DESCRIPTION OF THE DRAWINGS

To describe the technical solutions in the embodiments of this disclosure more clearly, the following briefly describes the accompanying drawings for the embodiments. Apparently, the accompanying drawings in the following description show merely some exemplary embodiments of this disclosure, and a person of ordinary skill in the art may still derive other drawings from these accompanying drawings without creative efforts.

FIG. 1 is a schematic structural diagram of a vehicle according to some exemplary embodiments of this disclosure;

FIG. 2 is an exploded view of a vehicle suspension system according to some exemplary embodiments of this disclosure;

FIG. 3 is a front view of a vehicle suspension system according to some exemplary embodiments of this disclosure;

FIG. 4 is a left view of a vehicle suspension system according to some exemplary embodiments of this disclosure;

FIG. 5 is a top view of a vehicle suspension system according to some exemplary embodiments of this disclosure; and

FIG. 6 is an axonometric view of a vehicle suspension system according to some exemplary embodiments of this disclosure.

### DETAILED DESCRIPTION

The following description provides specific application scenarios and requirements of this disclosure, to enable a person skilled in the art to make and use content of this disclosure. Various partial modifications to the disclosed embodiments are obvious to a person skilled in the art. General principles defined herein can be applied to some exemplary embodiments and applications without departing from the spirit and scope of this disclosure. Therefore, this disclosure is not limited to the illustrated embodiments, but is to be accorded the widest scope consistent with the claims.

The terms used herein are only intended to describe specific exemplary embodiments and are not restrictive. For example, as used herein, singular forms “a”, “an”, and “the” may also include plural forms, unless otherwise clearly specified in a context. When used in this disclosure, the terms “comprise”, “include”, and/or “contain” indicate presence of associated features, integers, steps, operations, elements, and/or components, but do not preclude presence of one or more other features, integers, steps, operations, elements, components, and/or groups or addition of other features, integers, steps, operations, elements, components, and/or groups to the system/method.

In view of the following description, these features and other features of this disclosure, operations and functions of related elements of structures, and economic efficiency in combining and manufacturing components can be significantly improved. All of these form a part of this disclosure with reference to the drawings. However, it should be clearly understood that the drawings are only for illustration and description purposes and are not intended to limit the scope of this disclosure. It should also be understood that the drawings are not drawn to scale.

Flowcharts used in this disclosure show operations implemented by the system according to some exemplary embodiments of this disclosure. It should be clearly understood that operations in the flowcharts may be implemented out of order. Conversely, the operations may be implemented in a reverse order or simultaneously. In addition, one or more other operations may be added to the flowcharts, and one or more operations may be removed from the flowcharts.

In this disclosure, “X includes at least one of A, B, or C” means: X includes at least A, or X includes at least B, or X includes at least C. In other words, X may include only any one of A, B, and C, or may include any combination of A, B, and C, and other possible content or elements. Any combination of A, B, and C may be A, B, C, AB, AC, BC, or ABC.

In this disclosure, unless explicitly stated otherwise, an association relationship between structures may be a direct association relationship or an indirect association relationship. For example, in the description of “A is connected to B”, unless it is explicitly stated that A is directly connected to B, it should be understood that A may be directly connected to B or indirectly connected to B. In another example, in the description of “A is above B”, unless it is explicitly stated that A is directly above B (A and B are adjacent and A is above B), it should be understood that A may be directly above B or indirectly above B (A and B are separated by another element and A is above B). The rest may be inferred by analogy.

A vehicle suspension system in the existing technology connects wheels and a vehicle body using a linkage mechanism, so that the wheels have a higher degree of freedom relative to the vehicle body, thereby obtaining better driving experience. In addition, the linkage mechanism can reduce an anti-rollover force arm of the vehicle body (a force arm from a wheel to a gravity axis of the vehicle body is reduced to a force arm from a hinge point of a linkage and the vehicle body to the gravity axis of the vehicle body), and an anti-rollover torque of the vehicle body is also reduced. When the vehicle body is disturbed by external forces, it is easier to shake and difficult to return to a right position, causing tilting or even rollover.

A vehicle suspension system provided in this disclosure is intended to fully retain advantages of a linkage mechanism as a suspension system, while avoiding disadvantages caused by use of the linkage mechanism. Based on the foregoing considerations and analysis of an anti-rollover torque, the suspension system in this disclosure is provided with a restoring apparatus. When the balance of a vehicle body is broken, the restoring apparatus can make a response plan based on a tilt of the vehicle body, and drive the vehicle body to return to an equilibrium position by reasonably matching acting forces applied between the vehicle body and wheels.

The vehicle suspension system provided in this disclosure is provided with actuating elements on both sides of the vehicle body, where the actuating elements constitute the restoring apparatus to provide acting forces between the vehicle body and the wheels from both sides of the vehicle body, so that the vehicle body is in the equilibrium position. When the vehicle body deviates from the equilibrium position, the two actuating elements generate acting forces of different magnitudes to drive the vehicle body to return to the equilibrium position. The vehicle suspension system provided in this disclosure can overcome the problems that a vehicle body is easy to shake and difficult to balance due to a high degree of freedom of wheels in a suspension system connected by a linkage mechanism. In addition, the restoring apparatus does not affect working of the linkage mechanism, that is, experience of the vehicle during driving is not affected.

The vehicle provided in this disclosure may be a short-distance commuter vehicle, such as a kick scooter, a tricycle, or a self-balancing scooter. In the present disclosure, the term “commuter vehicle” refers to any type of transportation designed primarily for short-distance travel, typically for daily commutes to and from work, school, or other regular destinations. Commuter vehicles in the present disclosure are intended to provide convenience, efficiency, and reliability for frequent use and can include a wide range of modes of transport such as, but not limited to, bicycles, electric bikes, scooters (e.g., kick scooters, mobility scooters, and electric scooters), self-balancing personal transporters (e.g., self-balancing scooters, hoverboards, self-balancing unicycles), motorcycles, compact cars, and personal mobility devices, etc. The vehicle herein is small in size and light in weight, and is very suitable for short-distance travel. In particular, a size in a width direction of the vehicle is small. The width direction of the vehicle may be an axial direction of the wheels of the vehicle. In other words, a wheel track of the vehicle is small. In addition, due to the small wheel track, the vehicle is more likely to roll over.

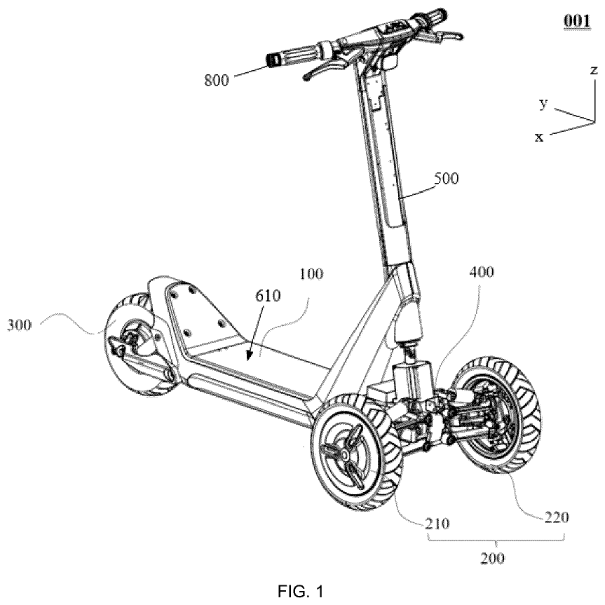

FIG. 1 is a schematic structural diagram of a vehicle 001 according to some exemplary embodiments of this disclosure. As shown in FIG. 1, a vehicle 001 may include a vehicle body 100, a pair of wheels 200, and a suspension system 400.

The vehicle body 100 may be a base and a main structure of the vehicle 001. The vehicle body 100 may be configured to connect various components of the vehicle 001, such as the wheels 200 and the suspension system 400. The vehicle body 100 may also be configured to carry a user. The vehicle body 100 may have a variety of different structures to adapt to different application scenarios. For example, a vehicle body 100 of a self-balancing scooter, a tricycle, a kick scooter, or the like may have different structures. FIG. 1 in this disclosure is described using a three-wheel kick scooter as an example. A person skilled in the art should understand that other structures of the vehicle body 100 also fall within the protection scope of this disclosure. A material of the vehicle body 100 may be a metal material, such as carbon steel, aluminum alloy, titanium alloy, or carbon fiber. The material of the vehicle body 100 may alternatively be a combination of a variety of different materials. This is not limited in this disclosure.

The base is generally designed to include a base structure 600 capable of carrying a user. The base structure 600 is generally provided with a standing area 610 for the user to stand. As shown in FIG. 1, the standing area 610 may be a smooth structure, that is, a surface of the standing area is a flat surface. The standing area 610 may alternatively include a rough structure. The rough structure may be formed by the surface of the standing area 610 itself, or the rough structure as a whole may be mounted on the surface of the standing area. A role of the rough structure is to enhance friction between the user and the standing area 610 to prevent the user from slipping. In some exemplary embodiments, the rough structure may be criss-cross raised stripes formed on the surface of the standing area 610. In some exemplary embodiments, the rough structure may be a honeycomb support plate provided on the surface of the standing area 610, and the support plate may be removable from the standing area 610. In some exemplary embodiments, the rough structure may be an anti-skid film or anti-skid mat provided on the surface of the standing area 610.

The main structure of the vehicle body refers to other parts of the vehicle body than the base structure 600. For example, the main structure may include a vehicle stem 500 and a handlebar 800. The vehicle stem 500 is generally used as a connecting structure between the handlebar 800 and the base structure 600, and plays a role in supporting and connecting the handlebar 800. In addition, the vehicle stem 500 also serves as a connector for other components. The vehicle stem 500 has a plurality of connection interfaces and a plurality of connectors. In some exemplary embodiments of this disclosure, the connection interfaces and connectors can be covered by a cover plate disposed on the vehicle stem 500, so that aesthetics and safety of the vehicle are improved.

The vehicle body 100 shown in FIG. 1 may include a steering wheel for the user to operate the vehicle 001. In some exemplary embodiments, the vehicle body 100 may further include a seat mounted in the standing area 610, so that the user can sit on the seat to drive the vehicle 001. In some exemplary embodiments, the vehicle body 100 may further include a storage unit for storing items. In some exemplary embodiments, the vehicle body 100 may also include other components. This is not limited in this disclosure.

A pair of wheels may be mounted at the bottom of the base structure 600, and the pair of wheels 200 may include a first wheel 210 and a second wheel 220. The first wheel 210 and the second wheel 220 may be located on two sides of the vehicle body 100 respectively, so that the vehicle body 100 can stand alone. The first wheel 210 and the second wheel 220 may be symmetrically distributed on two sides of the vehicle body 100. The pair of wheels 200 may be a driving part of the vehicle 001 to drive the vehicle 001 to move. The pair of wheels 200 may be connected to the vehicle body 100 to drive the vehicle body 100 to move. In some exemplary embodiments, the pair of wheels 200 may be connected to the vehicle body 100 via the suspension system 400.

In some exemplary embodiments, the vehicle 001 may include a pair of wheels 200. For example, the vehicle is a self-balancing scooter. In some exemplary embodiments, the vehicle 001 may further include other wheels, which may be distributed along a longitudinal direction of the vehicle body 100 with the pair of wheels 200. The longitudinal direction may be a driving direction of the vehicle body 100. In some exemplary embodiments, the pair of wheels 200 may be two front wheels of the vehicle 001. In this case, the vehicle 001 may further include a rear wheel 300. There may be one or two rear wheels 300, which are symmetrically distributed on both sides of the vehicle body 100. In some exemplary embodiments, the pair of wheels 200 may be rear wheels of the vehicle 001. In this case, the vehicle 001 may further include a front wheel 300. There may be one or two front wheels 300, which are symmetrically distributed on both sides of the vehicle body 100. The vehicle body 100 may connect the front wheel(s) and the rear wheel(s). The vehicle 001 shown in FIG. 1 is described by assuming that the pair of wheels 200 includes the front wheels of the vehicle 001. A person skilled in the art should understand that the pair of wheels 200 used as the rear wheels of the vehicle 001 also fall within the protection scope of this disclosure. The pair of wheels 200 may include pneumatic tires or solid rubber tires. This is not limited in this disclosure.

The suspension system 400 may be configured to connect the pair of wheels 200 and the vehicle body 100 of the vehicle 001. The suspension system 400 may be a general term for all force transmission connection apparatuses between the vehicle body 100 and the wheels of the vehicle 001. Its role is to transfer a force and torque applied between the wheels and the vehicle body. The suspension system 400 can also buffer an impact force transferred to the vehicle body 100 caused by an uneven road surface and reduce a shock caused by the impact force, so as to ensure smooth driving of the vehicle 001.

As shown in FIG. 1, for ease of description, the width direction of the vehicle body 100 is defined as a first direction X, the longitudinal direction of the vehicle body 100 is defined as a second direction Y, and a height direction of the vehicle body 100 is defined as a third direction Z. The width direction of the vehicle body 100 may be a direction in which the pair of wheels 200 is disposed, that is, an axial direction of the pair of wheels 200, or a wheel track direction of the pair of wheels 200. The longitudinal direction of the vehicle body 100 may be a driving direction of the vehicle 001 in a straight-ahead state, that is, an arrangement direction of the front and rear wheels, or the wheel track direction of the front and rear wheels. The height direction of the vehicle body 100 may be a vertical direction. The first direction, the second direction, and the third direction are perpendicular to each other.

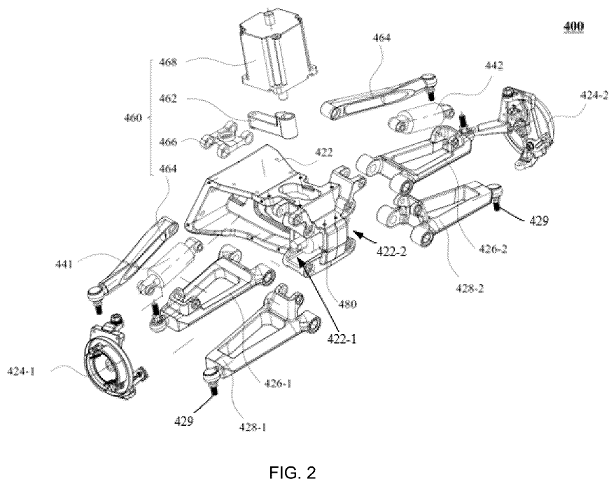

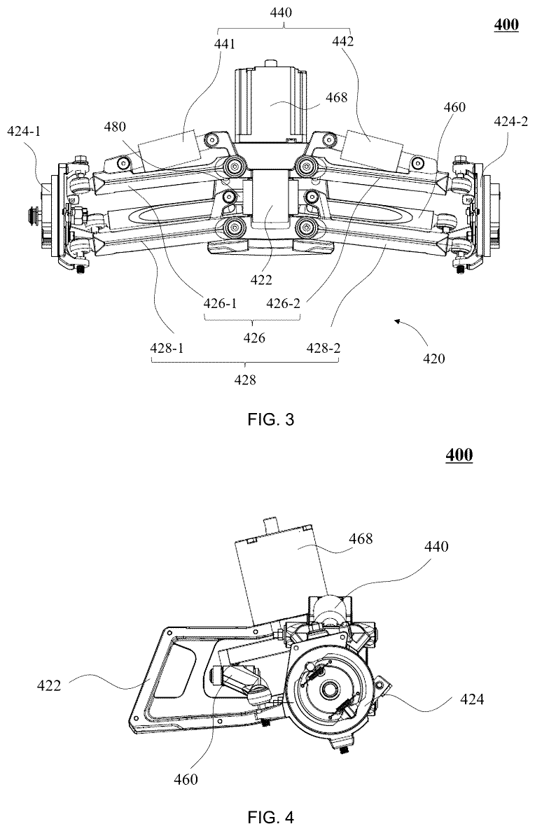

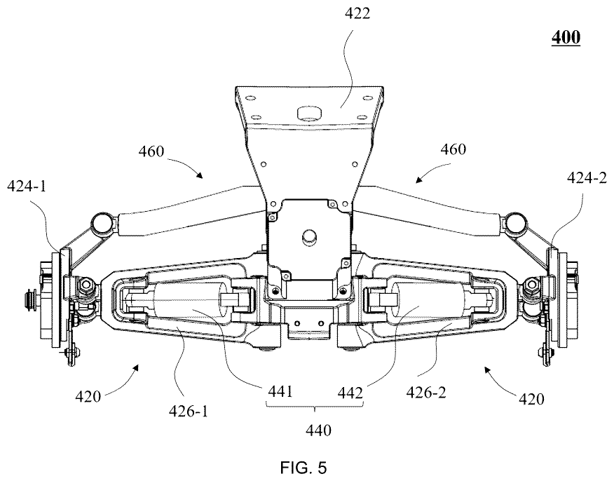

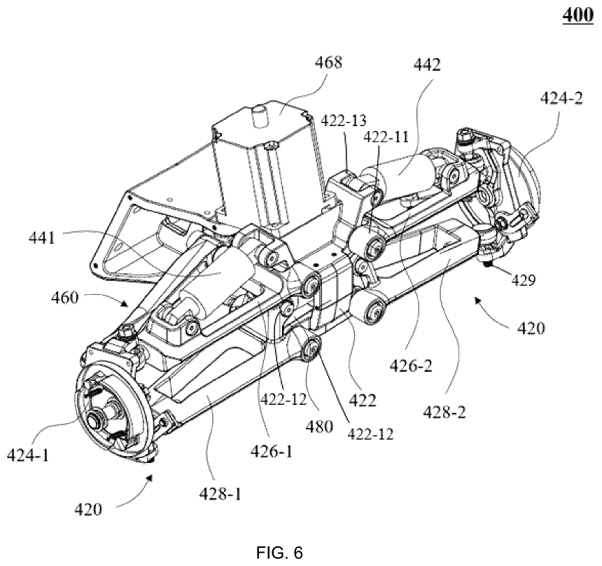

FIG. 2 is an exploded view of a suspension system 400 of a vehicle 001 according to some exemplary embodiments of this disclosure. FIG. 3 is a main view of a suspension system 400 of a vehicle 001 according to some exemplary embodiments of this disclosure. FIG. 4 is a left view of a suspension system 400 of a vehicle 001 according to some exemplary embodiments of this disclosure. FIG. 5 is a top view of a suspension system 400 of a vehicle 001 according to some exemplary embodiments of this disclosure. FIG. 6 is an axonometric view of a suspension system 400 of a vehicle 001 according to some exemplary embodiments of this disclosure. As shown in FIG. 2 to FIG. 6, the suspension system 400 may include a multi-linkage mechanism 420 and a restoring apparatus 440. In some exemplary embodiments, the suspension system 400 may also include a steering mechanism 460. In some exemplary embodiments, the suspension system 400 may also include a shock absorbing apparatus 480.

The multi-linkage mechanism 420 and the restoring apparatus 440 are main components of the suspension system 400. In the embodiments disclosed in this disclosure, there are a plurality of cooperation relationships between the multi-linkage mechanism 420 and the restoring apparatus 440. A primary function of the restoring apparatus 440 is to connect a vehicle body 100 and a pair of wheels 200. The restoring apparatus 440 generates an acting force based on a tilt relationship between the vehicle body 100 and the pair of wheels 200 to keep the vehicle body in an equilibrium position or restore the vehicle body back to an equilibrium position. The steering mechanism 460 and the shock absorbing apparatus 480 may both be used as components of the suspension system. Depending on different use scenarios and different functional requirements for the suspension system, the steering mechanism 460 and/or the shock absorbing apparatus 480 may be provided for the suspension system in different cases.

The multi-linkage mechanism 420 may connect the vehicle body 100 and the pair of wheels 200 during working. “Working” herein may be a state in which the suspension system 400 is mounted on the vehicle 001. The multi-linkage mechanism 420 generally refers to a suspension structure including three or more linkages and capable of providing control forces in a plurality of directions, so that the wheels 200 may have a more reliable driving trajectory. The multi-linkage mechanism 420 can not only ensure comfort, but also make the pair of wheels 200 of the vehicle 001 as vertical as possible relative to the ground during driving because of the large number of linkages, and reduce a tilt of the vehicle body 100 as much as possible to keep the wheels 200 in contact with the ground. The multi-linkage mechanism 420 may be a three-linkage mechanism, a four-linkage mechanism, or a five-linkage mechanism. Certainly, on a basis of a reasonable material selection and size design, the multi-linkage mechanism 420 may alternatively be a two-linkage mechanism.

In some exemplary embodiments, the multi-linkage mechanism 420 may be a four-linkage mechanism, as shown in FIG. 2 to FIG. 6, where the four-linkage mechanism 420 enables the pair of wheels 200 to move in a vertical direction relative to the vehicle body 100. The four-linkage mechanism may include a base 422, a pair of wheel bases 424, an upper fork arm 426, and a lower fork arm 428.

The base 422 may be fixedly connected to the vehicle body 100 during working. “Working” herein may be a state in which the suspension system 400 is mounted on the vehicle 001. The suspension system 400 may be connected to the vehicle body 100 via the base 422. The fixed connection may be implemented in a variety of manners, such as threaded connection, welding, riveting, and integral molding.

It should be noted that the restoring apparatus 440 described above is intended to connect the pair of wheels 200 and the vehicle body 100, and that the base 422 is a component fixedly connected to the vehicle body 100. In this case, the restoring apparatus 440 may be connected to the vehicle body 100 via the base 422, that is, at least one end of the restoring apparatus 440 may be connected to the base 422, so that the restoring apparatus 440 can be integrated into the four-linkage mechanism, making the suspension system more concentrated and compact in a structural design.

The base 422 has strength requirements. Therefore, the base 422 can be made by a sheet metal process. In addition, to avoid affecting the balance of the vehicle body 100, the base 422 may be designed as a symmetrical structure, so that after the base 422 is mounted on the vehicle body 100, a symmetry axis of the base 422 can coincide with a second direction. In addition, the vehicle body 100 is located between the pair of wheels 200. In this case, to facilitate assembly of the upper fork arm 426 and the lower fork arm 428, the base 422 may be configured to include a first mounting portion 422-1 and a second mounting portion 422-2, where the first mounting portion 422-1 and the second mounting portion 422-2 are disposed opposite to each other and correspond to the pair of wheels 200. In some exemplary embodiments, the base 422 may be further provided with a third mounting portion between the first mounting portion 422-1 and the second mounting portion 422-2. In some exemplary embodiments, the base 400 may alternatively be provided with only the third mounting portion.

The pair of wheel bases 424 may be respectively rotatably connected to the pair of wheels 200 around a first direction to achieve driving of the vehicle 001. The pair of wheel bases 424 may include a first wheel base 424-1 and a second wheel base 424-2. The first wheel base 424-1 may be rotatably connected to a first wheel 210 during working. The second wheel base 424-2 may be rotatably connected to a second wheel 220 during working.

It should be noted herein that the pair of wheels 200 may be mounted on the pair of wheel bases 424, so that the restoring apparatus 440 can be connected to the pair of wheels 200 via the pair of wheel bases 424, that is, the other end of the restoring apparatus 440 may be connected to the wheel base 424, so that the restoring apparatus 440 can be integrated into the four-linkage mechanism, making the suspension system more concentrated and compact in the structural design. Certainly, it is further to be noted in the following description that the other end of the restoring apparatus 400 for connecting the pair of wheels 200 may also be directly connected to the upper fork arm 426 or the lower fork arm 428 to implement a connection with the pair of wheels 200. It may be appreciated that, in some exemplary embodiments of this disclosure, the four-linkage mechanism is used as an example to systematically describe the suspension system as a whole and the restoring apparatus 440, where the restoring apparatus 440 is designed to be connected to the base 422 and the upper fork arm 426 or the base 400 and the lower fork arm 428. However, it is readily understandable that the restoring apparatus 440 may also be directly connected to the vehicle body 100 and the pair of wheels 200, or the restoring apparatus 440 may also be directly connected to the vehicle body 100 and the pair of wheel bases 424, or the restoring apparatus 440 may also be directly connected to the base 422 and the pair of wheel bases 424. The connection relationships are not limited in this disclosure, provided that the restoring apparatus 440 can act between the pair of wheels 200 and the vehicle body 100.

In some exemplary embodiments, the rotation of the pair of wheels 200 may be driven manually. In some exemplary embodiments, a power apparatus may be mounted on the first wheel base 424-1 and/or the second wheel base 424-2 to drive the first wheel 210 and/or the second wheel 220 to rotate. The power apparatus may be a motor or a combination of a motor and a speed reducer. The power apparatus may be mounted on the first wheel base 424-1 and/or the second wheel base 424-2, and its power output shaft may be directly or indirectly connected to the first wheel 210 and/or the second wheel 220 to provide power for the first wheel 210 and/or the second wheel 220.

The upper fork arm 426 is connected to the base 422 and the pair of wheel bases 424 respectively in a manner capable of floating (i.e., being movable) along the vertical direction. The lower fork arm 428 is connected to the base 422 and the pair of wheel bases 424 respectively in a manner capable of floating (i.e., being movable) along the vertical direction.

The floating (i.e., mobility) of the upper fork arm 426 along the vertical direction is generally manifested as the upper fork arm 426 moving up or down in the vertical direction when subjected to an external force. The external force is generally caused when the vehicle turns or drives on a road of an uneven surface. For example, when the vehicle travels from a flat road to a raised road, the pair of wheels 200 may be compressed by the road surface. In this case, a compression force may be fed back to the upper fork arm 426. To resist or eliminate the compression force, the upper fork arm 426 moves up appropriately, so that the compression force transferred to the vehicle body 100 is minimized. Floating (i.e., mobility) of the lower fork arm 428 along the vertical direction is generally manifested as the lower fork arm 428 moving up or down in the vertical direction when subjected to an external force. The external force is generally caused when the vehicle turns or drives on a road of an uneven surface. For example, when the vehicle travels from a flat road to a raised road, the pair of wheels 200 may be compressed by the road surface. In this case, the compression force may be fed back to the lower fork arm 428. To resist or eliminate the compression force, the lower fork arm 428 moves up appropriately, so that the compression force transferred to the vehicle body 100 is minimized. Functions of the suspension system can be performed by the foregoing actions of the upper fork arm 426 and the lower fork arm 428.

To achieve the floating (i.e., mobility) of the upper fork arm 426 and the lower fork arm 428, the upper fork arm 426 and the lower fork arm 428 may be connected to the base 422 and the pair of wheel bases 424 in a variety of manners.

In some exemplary embodiments, the upper fork arm 426 may be entirety unit, and the lower fork arm 428 may be another unit, so that the pair of wheels 200 may be connected together and affect each other during movement. In this case, the suspension system 400 is a non-independent suspension system. In this case, a connection point between the upper fork arm 426 and the base 422 may be located at a midpoint between a connection point of the upper fork arm 426 and the first wheel base 424-1 and a connection point of the upper fork arm 426 and the second wheel base 424-2, so that the vehicle can keep balance.

In the foregoing embodiments in which the upper fork arm 426 and the lower fork arm 428 are separate units, to cooperate with mounting of the upper fork arm 426 and the lower fork arm 428, the base 422 may be provided with a third mounting portion, where the third mounting portion is located at an axial position of the base 422. Central positions of the upper fork arm 426 and the lower fork arm are connected to the third mounting portion, and each forms a first connection point. An end of the upper fork arm 426 is connected to one of the pair of wheel bases 424, and the other end of the upper fork arm 426 is connected to the other one of the pair of wheel bases 424, forming two second connection points. An end of the lower fork arm 428 is also connected to one of the pair of wheel bases 424, and the other end of the lower fork arm 428 is connected to the other one of the pair of wheel bases 424, also forming two second connection points. On a basis of the foregoing mounting relationship, to simultaneously achieve floating (i.e., mobility) of the upper fork arm 426 and the lower fork arm 428, the first connection point is a hinge connection point, and the second connection point may be a hinge point or a movable connection point. The hinge connection point herein may be understood as a rotatable connection. In this case, the upper fork arm 426 and the lower fork arm 428 are hinged on the third mounting portion. Specifically, the following design scheme may be used: the upper fork arm 426 and the lower fork arm 428 both use a two-section structure, an end of the two-section structure is hinged together and forms a hinge hole, and the hinge hole is located in a middle position of the two-section structure. The third mounting portion is a boss that can be hinged to the hinge hole. The two-section structure also has two ends, where the two ends are correspondingly hinged to the pair of wheel bases 424, or the two ends are correspondingly mounted to the pair of wheel bases 424 by using a movable pin.

In some exemplary embodiments, the suspension system 400 may be an independent suspension system. In this case, the upper fork arm 426 may include a first upper fork arm 426-1 and a second upper fork arm 426-2. Two ends of the first upper fork arm 426-1 may be respectively rotatably connected to the base 422 and the first wheel base 424-1 around the second direction. Two ends of the second upper fork arm 426-2 may be respectively rotatably connected to the base 422 and the second wheel base 424-2 around the second direction. The first upper fork arm 426-1 and the second upper fork arm 426-2 may be symmetrically disposed. The lower fork arm 428 may include a first lower fork arm 428-1 and a second lower fork arm 428-2. Two ends of the first lower fork arm 428-1 may be respectively rotatably connected to the base 422 and the first wheel base 424-1 around the second direction. Two ends of the second lower fork arm 428-2 may be respectively rotatably connected to the base 422 and the second wheel base 424-2 around the second direction. The first lower fork arm 428-1 and the second lower fork arm 428-2 may be symmetrically disposed. The first upper fork arm 426-1 and the first lower fork arm 428-1 are disposed in parallel. The second upper fork arm 426-2 and the second lower fork arm 428-2 are disposed in parallel.

In the foregoing embodiments in which the suspension system 400 is an independent suspension system, the first upper fork arm 426-1 and the second upper fork arm 426-2 are two independent components. To cooperate with mounting of the first upper fork arm 426-1 and the second upper fork arm 426-2, the base 422 is provided with a first mounting portion 422-1 and a second mounting portion 422-2. The first upper fork arm 426-1 is connected between the first mounting portion 422-1 and the first wheel base 424-1, and the second upper fork arm 426-2 is connected between the second mounting portion 422-2 and the second wheel base 424-2. The first lower fork arm 428-1 and the second lower fork arm 428-2 are also two independent components. The first lower fork arm 428-1 is connected between the first mounting portion 422-1 and the first wheel base 424-1, and the second lower fork arm 428-2 is connected between the second mounting portion 422-2 and the second wheel base 424-2. To achieve the floating (i.e., mobility) of the upper fork arm 426 and the lower fork arm 428, in addition to the foregoing manner of both ends being rotatably connected around the second direction, a manner of one end being rotatably connected and the other end being movably connected may also be used. Specifically, one end of the first upper fork arm 426-1 is rotatably connected to the base 422, the other end of the first upper fork arm 426-1 is movably connected to the first wheel base 424-1, and the movable connection can be implemented by using a movable pin 429, so that the end connected to the first wheel base 424-1 can move along an axial direction of the movable pin 429; one end of the second upper fork arm 426-2 is rotatably connected to the base 422, the other end of the second upper fork arm 426-2 is movably connected to the second wheel base 424-2, and the movable connection can be implemented by using a movable pin 429, so that the end connected to the second wheel base 424-2 can move along an axial direction of the movable pin 429; one end of the first lower fork arm 428-1 is rotatably connected to the base 422, the other end of the first lower fork arm 428-1 is movably connected to the first wheel base 424-1, and the movable connection can be implemented by using a movable pin 429, so that the end connected to the first wheel base 424-1 can move along an axial direction of the movable pin; and one end of the second lower fork arm 428-2 is rotatably connected to the base 422, the other end of the second lower fork arm 428-2 is movably connected to the second wheel base 424-2, and the movable connection can be implemented by using a movable pin 429, so that the end connected to the second wheel base 424-2 can move along an axial direction of the movable pin. It should be noted that in the foregoing description, the rotatable connection manner and the connection manner of the movable pin 429 are each a type of movable connection. In some exemplary embodiments, the movable connection may alternatively be implemented by using a recess-protrusion structure, a sliding slot structure, or other structures.

It may be understood that when the pair of wheels 200 is subjected to an external force, the first lower fork arm 428-1 and the second lower fork arm 428-2 are the first to react. In other words, the first lower fork arm 428-1 and the second lower fork arm 428-2 are subjected to a greater impact force. Considering different magnitudes of impact forces, to ensure that the forces transferred to the base 422 are sufficiently balanced, this disclosure further designs connection points between the first upper fork arm 426-1 and the base 422, between the second upper fork arm 426-2 and the base 422, between the first lower fork arm 428-1 and the base 422, and between the second lower fork arm 428-2 and the base 422.

For example, in some exemplary embodiments, one first rotatable connection portion 422-11 is disposed in a position of the first mounting portion 422-1 corresponding to the first upper fork arm 426-1, two second rotatable connection portions 422-12 are disposed in positions of the first mounting portion 422-1 corresponding to the first lower fork arm 428-1, the two second rotatable connection portions 422-12 are disposed at an interval along the vertical direction, one first rotatable connection portion is disposed in a position of the second mounting portion 422-2 corresponding to the second upper fork arm 426-2, two second rotatable connection portions are disposed in positions of the second mounting portion 422-2 corresponding to the second lower fork arm, the two second rotatable connection portions are disposed at an interval along the vertical direction, the first upper fork arm 426-1 is connected to the first mounting portion 422-1 via the first rotatable connection portion 422-11, the second upper fork arm 426-2 is connected to the second mounting portion 422-2 via the first rotatable connection portion, the first lower fork arm 428-1 is connected to the first mounting portion 422-1 via the two second rotatable connection portions 422-12, and the second lower fork arm 428-2 is connected to the second mounting portion 422-2 via the two second rotatable connection portions. Therefore, it can be known that the first lower fork arm 428-1 and the second lower fork arm 428-2 are both connected to the base 422 via two connection points. This can not only ensure a more reliable connection relationship, but also improve a force transmission effect, so that the forces transferred from the first lower fork arm 428-1 and the second lower fork arm 428-2 to the base 422 are more balanced. Certainly, in some exemplary embodiments, there may also be other designs of connection points. For example, the first lower fork arm 428-1 and the second lower fork arm 428-2 may use three connection points, and the first upper fork arm 426-1 and the second upper fork arm 426-2 may use two connection points.

In the foregoing description, it can be known that the first upper fork arm 426-1, the second upper fork arm 426-2, the first lower fork arm 428-1, and the second lower fork arm 428-2 are all rotatably connected to the base 422. The specific structure used is not limited in this disclosure. For example, to implement rotation, generally, a hole-shaft cooperation manner may be used. Through holes may be made on the first upper fork arm 426-1, the second upper fork arm 426-2, the first lower fork arm 428-1, the second lower fork arm 428-2, and the base 422, and then a rotating shaft correspondingly passes through the through holes.

In some exemplary embodiments, the upper fork arm 426 and the lower fork arm 428 may be disposed in parallel, so that the four-linkage mechanism constitutes a parallel four-linkage mechanism. Therefore, the pair of wheel bases 424 and the pair of wheels 200 can always be parallel to the vehicle body, and stability of the vehicle body is better. In some exemplary embodiments, the first upper fork arm 426-1 and the first lower fork arm 428-1 may be disposed in parallel, and the second upper fork arm 426-2 and the second lower fork arm 428-2 may be disposed in parallel, so that the four-linkage mechanism constitutes a parallel four-linkage mechanism. Therefore, the pair of wheel bases 424 and the pair of wheels 200 can always be parallel to the vehicle body, and stability of the vehicle body is better.

In some exemplary embodiments, the upper fork arm 426 and the lower fork arm 428 may alternatively be non-parallel. For example, the upper fork arm 426 has a larger tilt angle. In some exemplary embodiments, the first upper fork arm 426-1 and the first lower fork arm 428-1 may alternatively be non-parallel, and the second upper fork arm 426-2 and the second lower fork arm 428-2 may alternatively be non-parallel. For example, the first upper fork arm 426-1 has a larger tilt angle than the first lower fork arm 428-1, and the second upper fork arm 426-2 has a larger tilt angle than the second lower fork arm 428-2.

In some exemplary embodiments, as shown in FIG. 2, the first upper fork arm 426-1, the second upper fork arm 426-2, the first lower fork arm 428-1, and the second lower fork arm 428-2 may each have a hollow design, thereby reducing the weight of the first upper fork arm 426-1, the second upper fork arm 426-2, the first lower fork arm 428-1, and the second lower fork arm 428-2, making the four-linkage mechanism lighter, improving sensitivity of the four-linkage mechanism to an external force, and improving the floating (i.e., mobility) performance of the four-linkage mechanism.

In some exemplary embodiments, the hollow design of the first upper fork arm 426-1, the second upper fork arm 426-2, the first lower fork arm 428-1, and the second lower fork arm 428-2 may adopts a manner of gradually expanding externally toward the base 422, so that the first upper fork arm 426-1, the second upper fork arm 426-2, the first lower fork arm 428-1, and the second lower fork arm 428-2 can transfer an external force more quickly. For example, the hollow design may use a trapezoidal structure. Using the first upper fork arm 426-1 as an example, the trapezoidal structure has two bottom sides, where the shorter bottom side is close to the first wheel base 424-1, and the longer bottom side is close to the base 422, so that when the first wheel 210 receives an impact, an impact force can be quickly transferred to the base 422 by the first upper fork arm 426-1, thereby instructing the restoring apparatus 440 to respond quickly. The hollow design concept of the second upper fork arm 426-2, the first lower fork arm 428-1, and the second lower fork arm 428-2 is not described in detail.

It should be noted that other structural forms of the multi-linkage mechanism 420 also fall within the protection scope of this disclosure.

The restoring apparatus 440 may include a pair of actuating elements distributed on two sides of the vehicle body 100. In some exemplary embodiments, the pair of actuating elements may be symmetrically distributed on two sides of the vehicle body 100. The restoring apparatus 440 may be connected to the vehicle body 100 and the pair of wheels 200 respectively during working to provide acting forces, so that the vehicle body 100 can be in the equilibrium position under a resultant force of the acting forces. When the vehicle body 100 deviates from the equilibrium position, the resultant force of the acting forces drives the vehicle body to return to the equilibrium position. When the vehicle body 100 is in the equilibrium position, the pair of actuating elements can provide acting forces of equal magnitudes but in opposite directions in the tilt direction of the vehicle body 100 to keep the vehicle body 100 in the equilibrium position. When the vehicle body 100 deviates from the equilibrium position, the resultant force of the acting forces provides, in the tilt direction of the vehicle body 100, a force opposite to the tilt direction for the vehicle body 100, to drive the vehicle body 100 to return to the equilibrium position. The tilt direction may be the first direction.

One of the pair of actuating elements connects the vehicle body 100 and the first wheel 210 during working, the other one of the pair of actuating elements connects the vehicle body 100 and the second wheel 210 during working, and the pair of actuating elements are configured to provide acting forces, so that the vehicle body 100 is in the equilibrium position under a resultant force of the acting forces. With reference to the foregoing embodiments, to make the suspension system more concentrated and compact in the structural design, the pair of actuating elements may be integrated into the multi-linkage mechanism. For example, as described above, the pair of actuating elements may be connected between the base 422 and the upper fork arm 426 or the lower fork arm 428.

The acting force provided by the actuating element for the vehicle body 100 may be a pull force or pressure. The pull force may be an attractive force, that is, a force that causes the vehicle body 100 and the wheel 200 to approach each other. The pressure may be a repulsive force, that is, a force that causes the vehicle body 100 and the wheel 200 to move away from each other. In some exemplary embodiments, when the vehicle body 100 is in the equilibrium position, each of the pair of actuating elements is in a compressed state, thereby providing pressure between the vehicle body 100 and the wheel 200. In some exemplary embodiments, when the vehicle body 100 is in the equilibrium position, each of the pair of actuating elements is in a stretched state, thereby providing a pull force between the vehicle body 100 and the wheel 200. To enable the vehicle 001 to overcome a centrifugal force when turning, the vehicle body 100 may tilt toward a center of the turn when the vehicle 001 turns. The acting forces provided by the actuating elements for the vehicle body 100 may be a pressure, that is, when the vehicle body 100 is in the equilibrium position, each of the pair of actuating elements is in the compressed state. For ease of description, in the following description, it is assumed that when the vehicle body 100 is in the equilibrium position, each of the pair of actuating elements is in the compressed state.

The pair of actuating elements may include a first actuating element 441 and a second actuating element 442. One end of the first actuating element 441 may be rotatably connected to the base 422, and the other end of the first actuating element 441 may be rotatably connected to the upper fork arm 426 or the lower fork arm 428. One end of the second actuating element 442 may be rotatably connected to the base 422, and the other end of the second actuating element 442 may be rotatably connected to the upper fork arm 426 or the lower fork arm 428. Specifically, one end of the first actuating element 441 may be rotatably connected to the base 422, and the other end of the first actuating element 441 may be rotatably connected to the first upper fork arm 426-1 or the first lower fork arm 428-1. One end of the second actuating element 442 may be rotatably connected to the base 422, and the other end of the second actuating element 442 may be rotatably connected to the second upper fork arm 426-2 or the second lower fork arm 428-2.

When the vehicle body 100 is in the equilibrium position, the first actuating element 441 and the second actuating element 442 provide acting forces of equal magnitudes but in opposite directions along the first direction for the vehicle body 100. The resultant force of the two forces keeps the vehicle body 100 in the equilibrium position. For example, the first actuating element 441 provides the vehicle body 100 with a force away from the first actuating element 441, and the second actuating element 442 provides the vehicle body 100 with a force away from the second actuating element 442, where the two forces are equal in magnitudes and opposite in directions.

When the vehicle body 100 is disturbed by an external force and deviates from the equilibrium position, the first actuating element 441 and the second actuating element 442 provide the vehicle body 100 with acting forces of different magnitudes and opposite directions along the first direction, and the vehicle body 100 moves toward the equilibrium position under a resultant force. For example, when the vehicle body 100 tilts in a direction toward the first actuating element 441, the first actuating element 441 is compressed and the acting force increases. In this case, the second actuating element 442 is stretched and the acting force decreases. Therefore, the acting force applied by the first actuating element 441 on the vehicle body 100 is greater than the force applied by the second actuating element 442 on the vehicle body 100, so that the resultant force of the acting forces points to a direction away from the first actuating element 441, thereby driving the vehicle body 100 to move in the direction away from the first actuating element 441, so that the vehicle body 100 returns to the equilibrium position. Conversely, when the vehicle body 100 tilts in a direction toward the second actuating element 442, its action in an opposite way. This is not described herein again herein.

To adapt to mounting of the first actuating element 441 and the second actuating element 442, as shown in FIG. 2 and FIG. 6, the base 422 may be further provided with a third rotatable connection portion 422-13 on the first mounting portion 422-1 and the second mounting portion 422-2 respectively, and the third rotatable connection portion 422-13 is located above the first rotatable connection portion 422-11 in the vertical direction. One end of the first actuating element 441 is rotatably connected to the third rotatable connection portion 422-13 on the first mounting portion 422-1, and the other end of the first actuating element 441 is rotatably connected to the first upper fork arm 426-1. One end of the second actuating element 442 is rotatably connected to the third rotatable connection portion on the second mounting portion, and the other end of the second actuating element 442 is rotatably connected to the second upper fork arm 426-2.

In some exemplary embodiments, the pair of actuating elements may be damping actuating elements or rigidity actuating elements. The pair of actuating elements may include at least one of a hydraulic actuating element, a pneumatic actuating element, or an elastic apparatus.

In some exemplary embodiments, the suspension system 400 may further include a steering mechanism 460. Two ends of the steering mechanism 460 may be rotatably connected to the vehicle body 100 and the pair of wheels 200 respectively to drive the pair of wheels 200 to steer relative to the vehicle body 100. As shown in FIG. 2 to FIG. 6, the steering mechanism 460 may include a steering rocker arm 462, a steering linkage 464, and a steering knuckle 466. Two ends of the steering rocker arm 462 may be respectively rotatably connected to the base 422 and the steering knuckle 466 around a third direction. One end of the steering linkage 464 is rotatably connected to the steering knuckle 466 around the second direction, the other end of the steering linkage 464 is rotatably connected to the pair of wheel bases 424 around the third direction. When the steering rocker arm 462 rotates relative to the base 422, the steering rocker arm 462 pulls the first wheel base 424 to steer. The hinge between the steering linkage 464 and the steering knuckle 466 allows the pair of wheel bases 424 to move in the third direction, so that the multi-linkage mechanism 420 can work normally.

To enable the pair of wheel bases 424 to rotate in the second direction relative to the upper fork arm 426 and the lower fork arm 428, and to rotate in the third direction relative to the steering linkage 464, the hinge between the pair of wheel bases 424 and the upper fork arm 426 and the lower fork arm 428 as well as the steering linkage 464 can be achieved by a ball joint.

In some exemplary embodiments, the steering mechanism 460 may further include a driving apparatus 468. The driving apparatus 468 may be mounted on the base 422. An output shaft of the driving apparatus 468 may be rotatably connected to the steering rocker arm 462 around the third direction, to drive the steering rocker arm 462 to rotate relative to the base 422. The driving apparatus 468 may include a motor, or include a combination of a motor and a speed reducer. In some exemplary embodiments, the driving apparatus may be in communication with a controller (not shown in FIG. 1 to FIG. 6) and operates based on a control signal sent by the controller. In some exemplary embodiments, the controller may be in communication with a remote computing device to receive a control signal from a remote control device, thereby achieving autonomous driving of the vehicle 001. In some exemplary embodiments, an input end of the driving apparatus 468 may alternatively be connected to a handlebar stem of the vehicle 001, so that a user can achieve steering of the vehicle 001 by operating the handlebar.

In some exemplary embodiments, to smoothly perform the function of the steering mechanism 460, as shown in FIG. 4 and FIG. 5, an end of the steering mechanism 460 connected to the pair of wheel bases 424 is approximately located between the upper fork arm 426 and the lower fork arm 428 in the vertical direction, thereby ensuring uniform force transmission and facilitating steering.

In some exemplary embodiments, the suspension system 400 may further include a shock absorbing apparatus 480. The shock absorbing apparatus 480 may be rotatably connected to the pair of wheels 200 and the vehicle body 100 respectively to achieve buffering. Specifically, two ends of the shock absorbing apparatus 480 may be hinged to the base 422 and the upper fork arm 426 or the lower fork arm 428 respectively. The shock absorbing apparatus 480 may be a damper, a rigidity actuator, or a combination of a damper and a rigidity actuator. The shock absorbing apparatus 480 may be an active shock absorbing apparatus, a semi-active shock absorbing apparatus, or a passive shock absorbing apparatus.

It should be noted that implementations in which the suspension system 400 does not include the steering mechanism 460 or the shock absorbing apparatus 480 also fall within the protection scope of this disclosure.

It should be noted that, for details of the suspension system 400 of the vehicle 001 not disclosed in the apparatus embodiments of this disclosure, reference may be made to the drawings of the specification provided in this disclosure. Details are not described herein again.

So far, the overall structure of the suspension system 400 and its possible combinations have been described thoroughly in this disclosure. With reference to some exemplary embodiments of this disclosure, the following further describes the features and advantages of the suspension system 400 for better understanding.

With reference to FIG. 2, FIG. 3, and FIG. 6, the suspension system 400 includes a four-linkage mechanism, a restoring apparatus 440, and a steering mechanism 460. The four-linkage mechanism includes a base 422, a first upper fork arm 426-1, a second upper fork arm 426-2, a first lower fork arm 428-1, a second lower fork arm 428-2, a first wheel base 424-1, and a second wheel base 424-2. The first upper fork arm 426-1, the second upper fork arm 426-2, the first lower fork arm 428-1, and the second lower fork arm 428-2 each have a hollow design, and the hollow design may have a trapezoid shape. An end of each of the first upper fork arm 426-1, the second upper fork arm 426-2, the first lower fork arm 428-1, and the second lower fork arm 428-2 is rotatably connected to the base 422, and an end of each of the first upper fork arm 426-1, the second upper fork arm 426-2, the first lower fork arm 428-1, and the second lower fork arm 428-2 is movably connected to a pair of wheel bases 424, where the movable connection is implemented by using a movable pin 429. The base 422 is provided with a first mounting portion 421 and a second mounting portion 422, the first upper fork arm 426-1 is connected to the first mounting portion 422-1 with one connection point, the second upper fork arm 426-2 is connected to the second mounting portion 422-2 with one connection point, the first lower fork arm 428-1 is connected to the first mounting portion 422-1 with two connection points, and the second lower fork arm 428-8 is connected to the second mounting portion 422-2 with two connection points. The restoring apparatus 440 includes a first actuating element 441 and a second actuating element 442, which are distributed on two sides of the vehicle body 100. One end of the first actuating element 441 is rotatably connected to the first mounting portion 422-1, and the other end of the first actuating element 441 is rotatably connected to the first upper fork arm 426-1. One end of the second actuating element 442 is rotatably connected to the second mounting portion 422-2, and the other end of the second actuating element 442 is rotatably connected to the second upper fork arm 426-2. The steering mechanism 460 includes a steering rocker arm 462, a steering linkage 464, a steering knuckle 466, and a driving apparatus 468. An end of the steering linkage 464 connected to the pair of wheel bases 424 is approximately located between the upper fork arm 426 and the lower fork arm 428 in a vertical direction.

In summary, in the suspension system 400 of the vehicle 001 provided in this disclosure, the actuating elements 440 disposed on two sides of the vehicle body 100 provide acting forces for the vehicle body, so that the vehicle body 100 is in the equilibrium position. When the vehicle body 100 deviates from the equilibrium position, the two actuating elements 440 generate acting forces of different magnitudes to drive the vehicle body 100 to return to the equilibrium position. The suspension system 400 of the vehicle 001 provided in this disclosure can overcome the problems that a vehicle body is easy to shake and difficult to balance due to a high degree of freedom of wheels in a suspension system connected by a linkage mechanism. The suspension system 400 of the vehicle 001 provided in this disclosure can also achieve steering with the steering mechanism 460, and can achieve automatic steering with the driving apparatus, thereby broadening use scenarios of the vehicle 001 and enabling driving of the vehicle 001 in a self-driving state.

Specific embodiments of this disclosure are described above. Some exemplary embodiments also fall within the scope of the appended claims. In some cases, the actions or steps described in the claims may be implemented in an order different from the order in the embodiments and the expected results can still be achieved. In addition, the processes depicted in the drawings do not necessarily require a specific order or sequence to achieve the expected results. In some implementations, multitask processing and parallel processing are also possible or may be advantageous.

In summary, after reading this detailed disclosure, a person skilled in the art may understand that the foregoing detailed disclosure may be presented by using examples only, and may not be restrictive. A person skilled in the art may understand that this disclosure needs to cover various reasonable changes, improvements, and modifications to the embodiments, although this is not specified herein. These changes, improvements, and modifications are intended to be proposed in this disclosure and are within the spirit and scope of the exemplary embodiments of this disclosure.

In addition, some terms in this disclosure are used to describe the embodiments of this disclosure. For example, “one embodiment”, “an embodiment”, and/or “some exemplary embodiments” mean/means that a specific feature, structure, or characteristic described with reference to the embodiment(s) may be included in at least one embodiment of this disclosure. Therefore, it may be emphasized and should be understood that in various parts of this disclosure, two or more references to “an embodiment” or “one embodiment” or “an alternative embodiment” do not necessarily all refer to the same embodiment. In addition, specific features, structures, or characteristics may be appropriately combined in one or more embodiments of this disclosure.

It should be understood that in the foregoing description of the embodiments of this disclosure, to help understand one feature, for the purpose of simplifying this disclosure, various features in this disclosure are combined in a single embodiment, single drawing, or description thereof. However, this does not mean that the combination of these features is necessary. It is possible for a person skilled in the art to mark out some of the devices as a separate embodiment for understanding after reading this disclosure. In other words, an embodiment in this disclosure may also be understood as an integration of a plurality of sub-embodiments. It is also true when content of each sub-embodiment may not include all features of a single embodiment as disclosed above.

Each patent, patent application, patent application publication, and other materials cited herein, such as articles, books, specifications, publications, documents, and materials, except any historical prosecution document associated therewith, any identical historical prosecution document that may be inconsistent or conflicting with this document, or any identical historical prosecution document that may have a restrictive effect on the broadest scope of the claims, can be incorporated herein by reference and used for all purposes associated with this document at present or in the future. In addition, if there is any inconsistency or conflict in descriptions, definitions, and/or use of a term associated with this document and descriptions, definitions, and/or use of the term associated with any material, the term in this document shall prevail.

Finally, it should be understood that the implementation solutions of this disclosure disclosed herein illustrate the principles of the implementation solutions of this disclosure. Other modified embodiments shall also fall within the scope of this disclosure. Therefore, the embodiments disclosed in this disclosure are merely exemplary and not restrictive. A person skilled in the art may use alternative configurations to implement the application in this disclosure according to the embodiments of this disclosure. Therefore, the embodiments of this disclosure are not limited to those embodiments precisely described in this disclosure.

What is claimed is:

1. A vehicle suspension system, comprising:
a multi-linkage mechanism, which connects a vehicle body and a pair of wheels, wherein the pair of wheels includes a first wheel and a second wheel respectively located on two sides of the vehicle body; and
a restoring apparatus, including a pair of actuating elements distributed on both sides of the vehicle body, wherein one of the pair of actuating elements connects the vehicle body and the first wheel, the other one of the pair of actuating elements connects the vehicle body and the second wheel, and the pair of actuating elements is configured to provide acting forces, so that the vehicle body is in an equilibrium position under a resultant force of the acting forces, wherein
when the vehicle body deviates from the equilibrium position, the resultant force of the acting forces drives the vehicle body to return to the equilibrium position.

2. The vehicle suspension system according to claim 1, wherein the pair of actuating elements is symmetrically distributed on both sides of the vehicle body,
when the vehicle body is in the equilibrium position, the pair of actuating elements provides acting forces of equal magnitudes and opposite directions in a tilt direction of the vehicle body to keep the vehicle body in the equilibrium position, and
when the vehicle body deviates from the equilibrium position, a resultant force of the acting forces provides, in a tilt direction of the vehicle body, a force opposite to the tilt direction for the vehicle body, to drive the vehicle body to return to the equilibrium position.

3. The vehicle suspension system according to claim 2, wherein when the vehicle body is in the equilibrium position, each of the pair of actuating elements is in a compressed state.

4. The vehicle suspension system according to claim 1, wherein the pair of wheels are front wheels of the vehicle, the vehicle further includes a rear wheel, and the vehicle body connects the front wheels and the rear wheel; or
the pair of wheels is rear wheels of the vehicle, the vehicle further includes a front wheel, and the vehicle body connects the front wheel and the rear wheels.

5. The vehicle suspension system according to claim 1, wherein the multi-linkage mechanism is a four-linkage mechanism, so that the pair of wheels is movable in a vertical direction relative to the vehicle body.

6. The vehicle suspension system according to claim 5, wherein the four-linkage mechanism includes:
a base, fixedly connected to the vehicle body during working;
a pair of wheel bases, respectively rotatably connected to the pair of wheels around a first direction during working to achieve driving of the vehicle, wherein the first direction is an axial direction of the pair of wheels;
an upper fork arm, connected to the base and the pair of wheel bases respectively and movable along the vertical direction; and
a lower fork arm, connected to the base and the pair of wheel bases respectively and movable along the vertical direction.

7. The vehicle suspension system according to claim 6, wherein the pair of wheel bases includes a first wheel base and a second wheel base, the first wheel base is rotatably connected to the first wheel during working, and the second wheel base is rotatably connected to the second wheel during working.

8. The vehicle suspension system according to claim 7, wherein the upper fork arm includes:
a first upper fork arm, having a first end rotatably connected to the base, and a second end movably connected to the first wheel base; and
a second upper fork arm, having a first end rotatably connected to the base, and a second end movably connected to the second wheel base.

9. The vehicle suspension system according to claim 8, wherein the first end and the second end of the first upper fork arm are respectively rotatably connected to the base and the first wheel base around a second direction, and
the first end and the second end of the second upper fork arm are respectively rotatably connected to the base and the second wheel base around the second direction, wherein
the second direction includes a longitudinal direction of the vehicle body.

10. The vehicle suspension system according to claim 9, wherein the lower fork arm includes:
a first lower fork arm, having a first end rotatably connected to the base, and a second end movably connected to the first wheel base; and
a second lower fork arm, having a first end rotatably connected to the base, and a second end movably connected to the second wheel base, wherein
the first upper fork arm and the first lower fork arm are disposed in parallel, and the second upper fork arm and the second lower fork arm are disposed in parallel.

11. The vehicle suspension system according to claim 10, wherein the first end and the second end of the first lower fork arm are respectively rotatably connected to the base and the first wheel base around the second direction, and
the first end and the second end of the second lower fork arm are respectively rotatably connected to the base and the second wheel base around the second direction.

12. The vehicle suspension system according to claim 11, wherein the base includes:
a first mounting portion, disposed opposite to the first wheel base; and
a second mounting portion, disposed opposite to the second wheel base, wherein
the first upper fork arm is connected between the first mounting portion and the first wheel base,
the second upper fork arm is connected between the second mounting portion and the second wheel base,
the first lower fork arm is connected between the first mounting portion and the first wheel base, and
the second lower fork arm is connected between the second mounting portion and the second wheel base.

13. The vehicle suspension system according to claim 12, wherein one first rotatable connection portion is disposed in a position of the first mounting portion corresponding to the first upper fork arm,
two second rotatable connection portions are disposed in positions of the first mounting portion corresponding to the first lower fork arm,
the two second rotatable connection portions are disposed at an interval along the vertical direction,
one first rotatable connection portion is disposed in a position of the second mounting portion corresponding to the second upper fork arm, two second rotatable connection portions are disposed in positions of the second mounting portion corresponding to the second lower fork arm, the two second rotatable connection portions are disposed at an interval along the vertical direction, the first upper fork arm is connected to the first mounting portion through the first rotatable connection portion, the second upper fork arm is connected to the second mounting portion through the first rotatable connection portion, the first lower fork arm is connected to the first mounting portion through the two second rotatable connection portions, and the second lower fork arm is connected to the second mounting portion through the two second rotatable connection portions.

14. The vehicle suspension system according to claim 13, wherein one third rotatable connection portion is disposed on either of the first mounting portion and the second mounting portion, and the third rotatable connection portion is located above the first rotatable connection portion in the vertical direction; and
the pair of actuating elements includes a first actuating element and a second actuating element, one end of the first actuating element is rotatably connected to the third rotatable connection portion on the first mounting portion, the other end of the first actuating element is rotatably connected to the first upper fork arm, one end of the second actuating element is rotatably connected to the third rotatable connection portion on the second mounting portion, and the other end of the second actuating element is rotatably connected to the second upper fork arm.

15. The vehicle suspension system according to claim 6, wherein
the pair of actuating elements includes the first actuating element and the second actuating element,
a first end of the first actuating element is rotatably connected to the base, a second end of the first actuating element is rotatably connected to the upper fork arm or the lower fork arm,
a first end of the second actuating element is rotatably connected to the base, and a second end of the second actuating element is rotatably connected to the upper fork arm or the lower fork arm.

16. The vehicle suspension system according to claim 6, further comprising:
a steering mechanism, rotatably connected to the vehicle body and the pair of wheels respectively to drive the pair of wheels to steer.

17. The vehicle suspension system according to claim 16, wherein
the steering mechanism includes a steering rocker arm, a steering linkage, and a steering knuckle,
a first end and a second end of the steering rocker arm are respectively rotatably connected to the base and the steering knuckle around a third direction,
a first end of the steering linkage is rotatably connected to the steering knuckle around the second direction, a second end of the steering linkage is rotatably connected to the pair of wheel bases around the third direction, and the third direction is the vertical direction of the vehicle body, wherein
when the steering rocker arm rotates relative to the base, the steering rocker arm pulls the first wheel base to steer.

18. The vehicle suspension system according to claim 17, wherein the steering mechanism further includes:
a driving apparatus, mounted on the base and rotatably connected to the steering rocker arm around the third direction, to drive the steering rocker arm to rotate relative to the base.

19. The vehicle suspension system according to claim 1, wherein the pair of actuating elements includes at least one of a hydraulic actuating element, a pneumatic actuating element, or an elastic apparatus.

20. The vehicle suspension system according to claim 1, further comprising:
a shock absorbing apparatus, rotatably connected to the pair of wheels and the vehicle body respectively.
